(19) United States
(12) Patent Application Publication
(10) Pub. No.: US 2004/0062026 A1
(43) Pub. Date: Apr. 1, 2004

(54) Method for producing an operational control, and operational control

(76) Inventor: Karsten Kirchhoff, Sehlem (DE)

Correspondence Address: KENYON & KENYON, ONE BROADWAY, NEW YORK, NY, 10004, US

(21) Appl. No.: 10/450,765

(22) PCT Filed: Dec. 13, 2001
(86) PCT No.: PCT/DE01/04691

(30) Foreign Application Priority Data
Dec. 15, 2000 (DE) 10062554.1

(51) Int. Cl. G01D 11/28

(52) U.S. Cl. 362/30

(57) ABSTRACT

In a method for manufacturing an operating element having a lightable lettering, a color imparting top coat is applied to a transparent part of the operating element which bears the lettering, the lettering is produced by partial removal of the top coat, a base coat, e.g. having a high contrast with the top coat, is applied to the transparent part before applying the top coat, and the lettering is produced by partial removal of at least the top coat. In an operating element having a lightable lettering, a part of the operating element which is made of a transparent material and bears the lettering is covered by a top coat, the lettering being implemented by partial removal of the top coat. A base coat, e.g. having a high contrast with the top coat, may be applied to the transparent part beneath the top coat, and the lettering may be implemented by partial removal of at least the top coat. The method and the operating element may provide that one and the same transparent material may be used to manufacture operating elements of different colors and also letterings which appear in different manners on the operating element.

### FIELD OF THE INVENTION

The present invention is directed to a method for manufacturing an operating element having a lightable lettering. The present invention is also directed to an operating element having a lightable lettering.

### BACKGROUND INFORMATION

Operating elements having a lightable lettering are conventional, for example, in the field of driver information systems for motor vehicles or for car radios. With the conventional devices, the operating elements are lighted entirely or partially for the purpose of recognizability of operating elements, even under poor lighting conditions, in particular at night. The operating elements may be manufactured at least partially from a transparent material which is coated with a top coat that determines the exterior appearance of the operating element and thus also that of the equipment. In the case of car radio equipment, the top coat may be partially removed in the form of a lettering or a symbol applied to the operating element, so that the transparent material beneath the top coat becomes visible at these locations. In the case of a backlighted operating element, rays of light which may be injected into the transparent part of the operating element pass through the cutouts in the top coat and thus may give the impression of a lighted lettering.

To obtain operating elements having different color designs and at the same time an adequate contrast of the lettering with the color of the operating element when the operating element is not lighted, different transparent materials may used. For example, in the case of an operating element coated with a light top coat, transparent materials pigmented in a dark hue may be used to achieve a sufficient contrast between the lettering on the operating element and the top coat of the operating element when unlighted. Conversely, light-colored transparent materials may be used for operating elements having a dark coating, so that when unlighted, a color of the lettering which may be determined by the transparent material is contrasted against the dark top coat in the unlighted state.

### SUMMARY

An example embodiment of the present invention is directed to a method for manufacturing an operating element having a lightable lettering, a color imparting top coat being applied to a transparent part of the operating element which bears the lettering, the lettering being produced by partial removal of the top coat. An operating element according to an example embodiment of the present invention has a lightable lettering, a part of the operating element which bears the lettering and is made of a transparent material being covered by a top coat, and the lettering being implemented by partial removal of the top coat.

The method may provide that one and the same transparent material may be used to manufacture operating elements of different colors. This may eliminate the need for manufacturing and storing blanks of transparent materials in different colors. Likewise, this may eliminate the cost of pigmenting the raw material and keeping inventories of the different colored blanks.

In addition, pigmentation of the transparent material may be omitted, so that the transparency is improved. This may also yield improved illumination of the lettering and/or symbols in the case of lighted operating elements. Furthermore, this may prevent a difference in the lighting color between differently pigmented operating elements in one and the same unit of equipment.

In an exemplary method, a base coat, which may have a high contrast with the top coat, may be applied before application of the top coat to the transparent part, and the lettering may be manufactured by partial removal of at least the top coat.

The foregoing may also be derived for an operating element having a lightable lettering, a part of the operating element which is made of transparent material and bears the lettering being covered by a top coat. The lettering may be implemented by partial removal of the top coat. A base coat, which may have a high contrast with the top coat, may be applied to the transparent part beneath the top coat, and the lettering may be implemented by partial removal of at least the top coat.

A dark color may be selected for the base coat and a light color may be selected for the top coat, and that the lettering may be produced by partial removal of both the top coat and the base coat.

This may also achieve a high contrast between the operating element lettering and the top coat for an unlighted operating element. For example, a dark base coat may cause a virtual pigmentation of the transparent material, which may be essentially neutral, so that it appears dark in the area of the lettering when the operating element is not lighted. At the same time, however, this virtual pigmentation of the transparent material may not result in any increase in optical resistance.

The opposite effect may be obtained when choosing a light base coat and a dark top coat. In this case, the light base coat may cause a virtual pigmentation of the transparent base material, so that in the case of an unlighted operating element, its lettering appears light and thus forms a high contrast with the dark top coat.

In this situation, it may be sufficient to partially apply a symbol or lettering only to the top coat if the base coat is sufficiently transparent for backlighting.

For lighting the lettering on an operating element according to the present invention, a light source whose light may be injected into the transparent part of the operating element may be provided.

According to another exemplary embodiment of the present invention, the transparent part outside of the lettering and outside of the area visible to the user, possibly on a back side of the operating element which protrudes into the apparatus to be operated, may have an uncoated surface through which light from the light source may be injected.

Exemplary embodiments of the present invention are illustrated in the figures and explained in greater detail below.

### BRIEF DESCRIPTION OF THE DRAWINGS

FIG. 1 shows a part of a front panel of a car radio having the operating elements implemented on it.

FIG. 2 shows a first section through the front panel part shown in FIG. 1.

FIG. 3 shows another section through the front panel part shown in FIG. 1.

FIG. 4 shows a section through an operating element implemented on the front panel according to FIG. 1.

### DETAILED DESCRIPTION

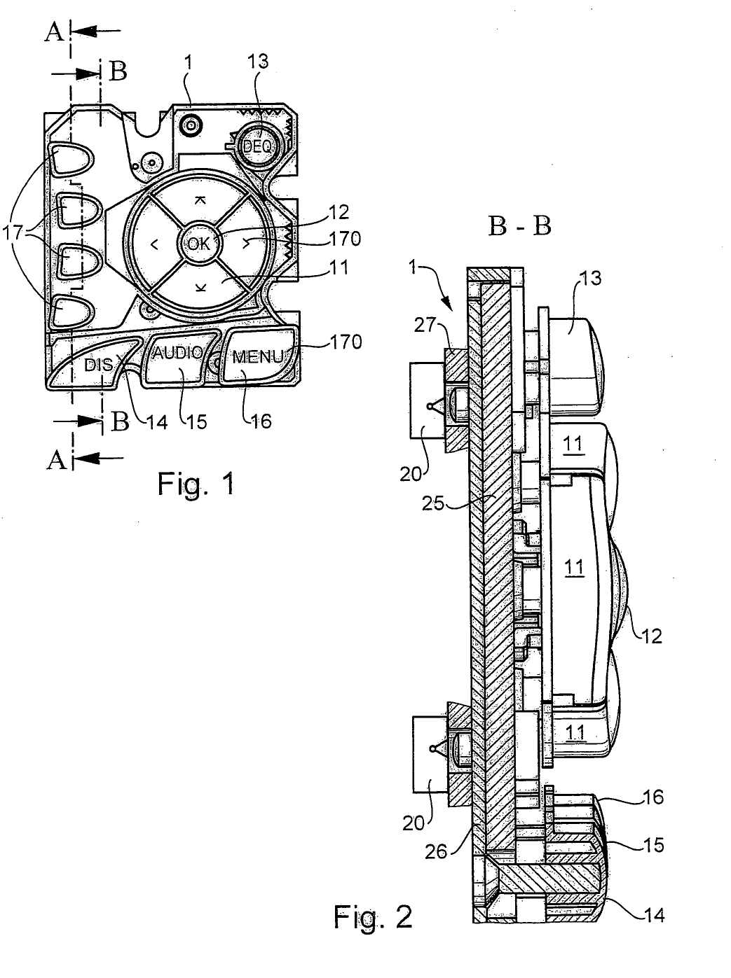

FIG. 1 shows a part of a front panel 1 having operating elements in it. The panel may be implemented in a car radio unit. Front panel 1 has operating elements 12, 13 and 17 which are provided with a dark color imparting top coat. For example, operating button 12, which bears the lettering “OK,” has a black top coat; another pushbutton 13, which bears the lettering “DEQ,” is provided with a dark blue top coat, and soft keys 17, which bear the lettering “-” and are assigned to the lines of a display situated at the side have a black top coat. Cursor buttons 11, which are provided with arrow symbols, and other operating elements 14, having the lettering “DIS,” operating element 15 having the lettering “AUDIO” and operating element 16 having the lettering “MENIU” have a silver-colored top coat.

FIG. 2 shows a section A through the part of front panel 1 of the car radio unit shown in FIG. 1, having cursor buttons 11, OK button 12, DEQ button 13, DIS button 14, AUDIO button 15 and MENU button 16. The buttons, i.e., operating elements, may be situated on a light guide 25 into which light is injected from light sources 20, e.g., in the form of LEDs. A switching mat 26, which may also be made of a transparent material, may be situated beneath the light guide.

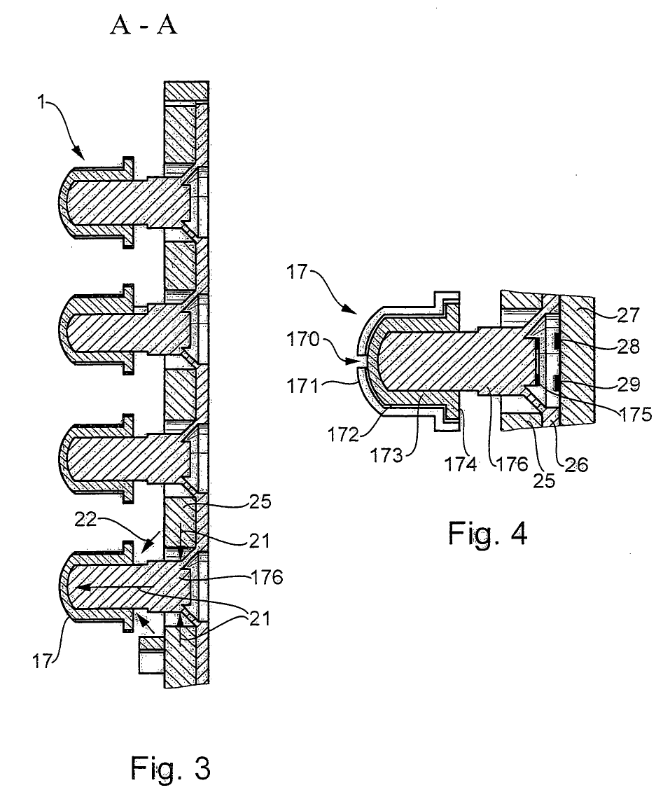

FIG. 3 shows a section B through car radio front panel 1 in the area of soft keys 17.

The light of light sources 20 injected into light guide 25 may come out of it and enter a transparent base body 176 of operating element 17. The transparent base body of the operating element may be made of silicone, as may be switching mat 26, and it may be connected to switching mat 26 by thin webs. Light injected into the switching mat may thus also be injected into base body 176 of the operating element via the webs. In addition, stray light coming out of base body 176 of the operating element, but also coming from light guide 25, may be injected into a cap made of transparent material on the operating element.

FIG. 4 shows an enlarged view of an operating element 17. A metallic contact ring 175 may be provided on the bottom side of base body 176 of operating element 17; when the operating element is depressed, it may electrically connect contacts 28 and 29 and/or printed conductors situated on the top of a circuit board 27 to initiate a switching operation. Cap 173 on the operating element according to the present invention may be made of a transparent material, which may be covered by a base coat 172 and a top coat 171 may be applied over that. In the area of the lettering, i.e., a symbol may be applied to the operating element, both base coat 172 and top coat 171 may have a gap through which light injected into operating element cap 173 may be able to pass.

To facilitate the injection of light into operating element cap 173 or to make it possible at all in the case of a non-transparent operating element base body 176, the operating element cap may not be coated on its bottom side 174. Thus, light injected into light guide 25 and stray light 22 emitted from it may be injected into the bottom side of operating element cap 173 and thus may be conducted through it and toward gap 170 in the coating.

Base coat 172 on operating element cap 173 and/or the transparent part of operating element 17 may have the function of a virtual coloring of the transparent material of operating element 17, i.e., its cap 173. A dark base coat may thus result in a virtual dark coloring of the transparent material, so that when the operating element is unlighted, symbol 170 may appear dark on the top side of the operating element.

Conversely, a light base coat on the operating element may have the effect that the symbol or lettering 170 of operating element 17 appears light when the operating element is not lighted.

To manufacture an operating element according to the present invention, operating element cap 173 may first be provided with a base coat which may determine the visual impression, namely the impression based on the color of the lettering. In a subsequent step, the operating element, i.e., operating element cap 173, may be coated with a top coat which may determine the color of the operating element. In a last method step, both the base coat and the top coat may be removed in the area of the lettering and/or a symbol to be applied, e.g., by using a suitable laser, so that the transparent base material in the form of the lettering or symbol appears through the top coat in the area where the material may have been removed.

In particular in the case of a dark top coat and a light top coat, only top coat 171 may have a gap corresponding to the symbol or the lettering. For the purpose of a sufficiently bright lighting of the symbol, the base coat may be sufficiently transparent and may be applied with a smaller layer thickness. This exemplary embodiment may be suggested for a black top coat and a white or yellow base coat, for example.

In this case, as an alternative to the exemplary manufacturing method described above, a particularly thin base coat may be applied, which may have a particularly transparent coat, with only the top coat being removed.

What is claimed is:

1. A method for manufacturing an operating element (17) having a lightable lettering (170), a color imparting top coat (171) being applied to a transparent part (173) of the operating element which bears the lettering, the lettering being produced by partial removal of the top coat,
wherein, before applying the top coat, a base coat (172), preferably having a high contrast with respect to the top coat, is applied to the transparent part, and
the lettering (170) is produced by partial removal of at least the top coat (171).

2. The method as recited in claim 1,
wherein a dark color is selected for the base coat and a light color is selected for the top coat, and the lettering is produced by partial removal of both the top coat and the base coat.

3. An operating element (17) having a lightable lettering (170), a part (173) of the operating element which is made of a transparent material and has the lettering (170) being covered by a top coat (171), and the lettering (170) being implemented by partial removal of the top coat (171),
wherein a base coat (172), preferably having a high contrast with respect to the top coat, is applied to the transparent part (173) beneath the top coat (171), and
the lettering (170) is implemented by partial removal of at least the top coat (171).

4. The operating element as recited in claim 4,
wherein the base coat (172) has a dark color and the top coat (171) has a light color, and the lettering (170) is implemented by partial removal of both the top coat and the base coat.

5. The operating element as recited in one of claims 4 or 5,
wherein a light source (20), whose light is injected into the transparent part (173) of the operating element, is provided for lighting the lettering (170).

6. The operating element as recited in claim 5,
wherein the transparent part (173) has an uncoated area (174) outside of the lettering, preferably on the back side of the operating element, so that the light of the light source (20) may be injected through this area.
